(19) United States
(12) Patent Application Publication
(10) Pub. No.: US 2005/0175019 A1
(43) Pub. Date: Aug. 11, 2005

(54) Wi-Fi service delivery platform for wholesale service providers

(75) Inventors: Asawaree Kalavade, Stowe, MA (US); Kevin Jackson, Groton, MA (US); Jeremy Greene, Acton, MA (US); Eric Bomarsi, Northborough, MA (US)

Correspondence Address: WILMER CUTLER PICKERING HALE AND DORR LLP, 60 STATE STREET, BOSTON, MA, 02109, US

(73) Assignee: Tatara Systems, Inc., Acton, MA (US)

(21) Appl. No.: 10/871,412

(22) Filed: Jun. 18, 2004

Related U.S. Application Data
(60) Provisional application No. 60/542,358, filed on Feb. 6, 2004.

(51) Int. Cl. H04L 12/56

(52) U.S. Cl. 370/400

(57) ABSTRACT

A method and apparatus are provided for managing usage of a plurality of local area networks by a plurality of subscribers. Each subscriber is associated with one of a plurality of retail service providers. The subscribers each have a terminal for accessing one or more of the local area networks. For each attempt by one of the plurality of subscribers to access one of the plurality of local area networks, the method includes the steps of: (a) receiving at a gateway at a wholesale service provider network a request from the one of the plurality of local area networks for authenticating the one of the plurality of subscribers. The request contains subscriber credentials for the one of the plurality of subscribers; (b) forwarding the subscriber credentials to a retail service provider with which the one of the plurality of subscribers is associated; (c) receiving from the retail service provider authorization to grant access to the one of the plurality of local area networks when the one of the plurality of subscribers is authenticated based on the subscriber credentials and information relating to the one of the plurality of subscribers previously stored in a subscriber database; (d) authorizing the one of the plurality of local area networks to grant access to the one of the plurality of subscribers when the one of the plurality of subscribers is authenticated; (e) receiving session information from the one of the plurality of local area networks on usage of the one of a plurality of local area networks by the one of the plurality of subscribers; and (f) transmitting the information received on local area network usage to the retail service provider for use in billing the one of the plurality of subscribers.

### RELATED APPLICATION

This application is based on and claims priority from Provisional Application Ser. No. 60/542,358 filed on Feb. 6, 2004 and entitled WI-FI SERVICE DELIVERY PLATFORM FOR WHOLESALE SERVICE PROVIDERS, which is incorporated by reference herein in its entirety.

### BACKGROUND OF THE INVENTION

1. Field of the Invention

The present invention relates generally to data networks and, more particularly, to a delivery platform for providing public wireless LAN (i.e., “Wi-Fi”) service.

2. Description of Related Art

Wireless data technologies are used to provide Internet and other network access to mobile client devices such as, e.g., laptops and personal digital assistants (PDAs). For example, enterprises and universities are now widely deploying wireless local area networks (LANs) based on the IEEE 802.11 standard. Users with client devices such as laptops and PDAs use an 802.11 network interface card that allows them wireless access to the Internet. In addition to replacing traditional Ethernet-based local area networks, these wireless LANs are now also being deployed in novel settings. Of special interest is the increasing deployment of these 802.11 based networks in public spaces and hot spots such as, e.g., airports, convention centers, hotels, and even local coffee shops. These hotspots can provide Wi-Fi service at fast speeds.

### BRIEF SUMMARY OF EMBODIMENTS OF THE INVENTION

In accordance with one or more embodiments of the invention, a method is provided for managing usage of a plurality of local area networks by a plurality of subscribers. Each subscriber is associated with one of a plurality of retail service providers. The subscribers each have a terminal for accessing one or more of the local area networks. For each attempt by one of the plurality of subscribers to access one of the plurality of local area networks, the method includes the steps of: (a) receiving at a gateway at a wholesale service provider network a request from the one of the plurality of local area networks for authenticating the one of the plurality of subscribers. The request contains subscriber credentials for the one of the plurality of subscribers; (b) forwarding the subscriber credentials to a retail service provider with which the one of the plurality of subscribers is associated; (c) receiving from the retail service provider authorization to grant access to the one of the plurality of local area networks when the one of the plurality of subscribers is authenticated based on the subscriber credentials and information relating to the one of the plurality of subscribers previously stored in a subscriber database; (d) authorizing the one of the plurality of local area networks to grant access to the one of the plurality of subscribers when the one of the plurality of subscribers is authenticated; (e) receiving session information from the one of the plurality of local area networks on usage of the one of a plurality of local area networks by the one of the plurality of subscribers; and (f) transmitting the information received on local area network usage to the retail service provider for use in billing the one of the plurality of subscribers.

In accordance with one or more embodiments of the invention, a gateway is provided for deployment at a wholesale service provider network for managing usage of a plurality of local area networks by a plurality of subscribers. Each subscriber is associated with one of a plurality of retail service providers. The subscribers each have a terminal for accessing one or more of the local area networks. The gateway includes: a first interface module for communicating with the plurality of local area networks; and a second interface module for communicating with the plurality of retail service providers. The gateway also includes a manager for receiving through the first interface module requests from the plurality of local area networks for authenticating subscribers desiring access to the plurality of local area networks. The requests contain subscriber credentials for the subscribers. The manager transmits through the second interface module the subscriber credentials to respective retail service providers with which the subscribers are associated. The manager receives from the retail service providers through the second interface module authorization to grant subscribers access to respective local area networks when the subscribers are authenticated based on subscriber credentials and information relating to the subscribers previously stored in a subscriber database. The manager authorizes the local area networks to grant access to authenticated subscribers through the first interface module. The manager also receives session information from the plurality of local area networks on usage of the local area networks by the subscribers. The manager transmits the information received on local area network usage to the retail service providers for use in billing the plurality of subscribers.

In accordance with one or more embodiments of the invention, a method is provided for managing usage of a plurality of local area networks by a plurality of subscribers. Each subscriber is associated with one of a plurality of retail service providers. The subscribers each have a terminal for accessing one or more of the local area networks. For each attempt by one of the plurality of subscribers to access one of the plurality of local area networks, the method comprises the steps of: (a) receiving at a retail service provider associated with the one of the plurality of subscribers a request from the one of the plurality of local area networks for authenticating the one of the plurality of subscribers. The request is received via a gateway at a wholesale service provider network. The request contains subscriber credentials for the one of the plurality of subscribers; (b) authenticating the one of the plurality of subscribers based on the subscriber credentials and information relating to the one of the plurality of subscribers previously stored in a subscriber database; (c) transmitting to the gateway authorization to grant access to the one of the plurality of local area networks when the one of the plurality of subscribers is authenticated. The gateway transmits to the one of the plurality of local area networks authorization to grant access to the one of the plurality of subscribers; and (d) receiving from the one of the plurality of local area networks via the gateway information on local area network usage by the one of the plurality of subscribers for use in billing the one of the plurality of subscribers.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 is a simplified diagram of a Wi-Fi service delivery platform for wholesale service providers in accordance with one or more embodiments of the invention;

FIG. 2 is a simplified diagram of a Wi-Fi service delivery platform for retail service providers in accordance with one or more embodiments of the invention;

FIG. 3 is a simplified diagram of a Partner Gateway deployment in accordance with one or more embodiments of the invention;

FIG. 4 is a simplified diagram of a Partner Gateway cluster in accordance with one or more embodiments of the invention;

FIG. 5 is a simplified diagram of components of a Partner Gateway in accordance with one or more embodiments of the invention;

FIG. 6 is a simplified diagram of the system architecture of a Partner Gateway in accordance with one or more embodiments of the invention;

FIG. 7 is a simplified diagram of cluster details of a Partner Gateway in accordance with one or more embodiments of the invention;

FIG. 8 is a simplified diagram of multi-site Partner Gateway clusters in accordance with one or more embodiments of the invention;

FIG. 9 is a simplified diagram of the software architecture of a Partner Gateway in accordance with one or more embodiments of the invention;

FIG. 10 is a simplified diagram of an exemplary operation sequence in accordance with one or more embodiments of the invention; and

FIG. 11 is a simplified diagram of a hosted offering of a wholesale service provider in accordance with one or more embodiments of the invention.

### DETAILED DESCRIPTION OF PREFERRED EMBODIMENTS

The present application relates to a Wi-Fi Service Delivery Platform having components that can function independently or can work together to deliver the broad set of Wi-Fi capabilities. The platform accelerates the path to profitability for public wireless LAN (Wi-Fi) service providers by enabling both retail and wholesale service providers to profitably support roaming relationships—or even become “virtual providers” of public Wi-Fi services—without sacrificing security, control or advanced capabilities.

The Wi-Fi Service Delivery Platform has components that serve the needs of both retail service providers and wholesale operators or aggregators in the public Wi-Fi services space.

Wholesale Solution

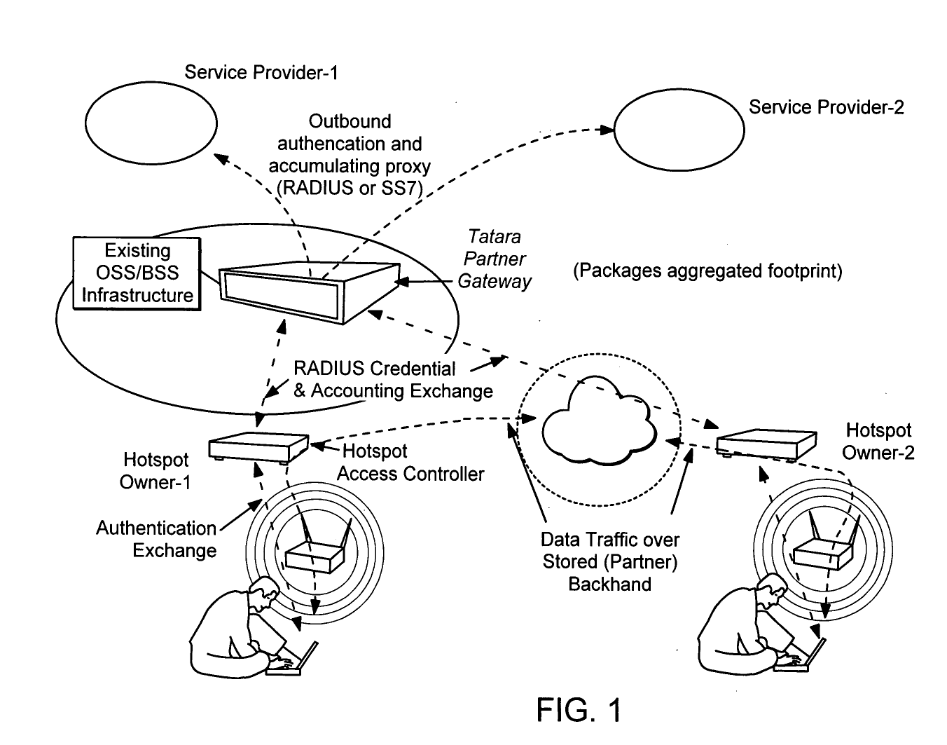

Wholesale operators, including aggregators, are challenged to maximize the value of their network assets through inbound roaming. Doing so requires balancing one's own needs with the needs of retail service provider ‘customers’ and local venue partners. From the wholesale operator's perspective, one core need is to support inbound roaming in a manner that is manageable, scalable, highly reliable and facilitates settlement with a range of partners. In addition, to maximize the value of the hotspot venue and support local constituencies, the wholesale operator needs to enable access to local venue applications and services. As shown in FIG. 1, a Wi-Fi Service Delivery Platform in accordance with one or more embodiments of the invention for wholesale operators includes a Partner Gateway, which is a centrally deployed and managed network device that facilitates partnerships and enables inbound roaming on Wi-Fi networks owned or controlled by a Wi-Fi aggregator. The Partner Gateway enables a Wi-Fi wholesale network operator to configure and support inbound roaming relationships easily and securely with a broad range of retail service provider partners. The system manages the real-time delivery of AAA or GSM MAP information to these partners from a central platform, supports delivery of local venue services and feeds roaming usage information to a wholesale billing/settlement platform or external clearinghouse. The Partner Gateway is a standards-based platform which does not require that the retail partners have any specific infrastructure other than a RADIUS server or terminating HLR.

Retail Solution

Retail service providers—providers who own direct relationships with end users—are constantly challenged to excel at meeting the needs of their end users. In the public Wi-Fi service market, these needs can include, e.g., (1) broad service coverage across key venues, (2) a simple, reliable and high-quality end user experience, (3) enterprise-quality security in a public environment, (4) access to a suite of local and global applications, (5) enterprise-level management of end user usage and costs, and (6) affordable pricing plans for enterprise and individual users.

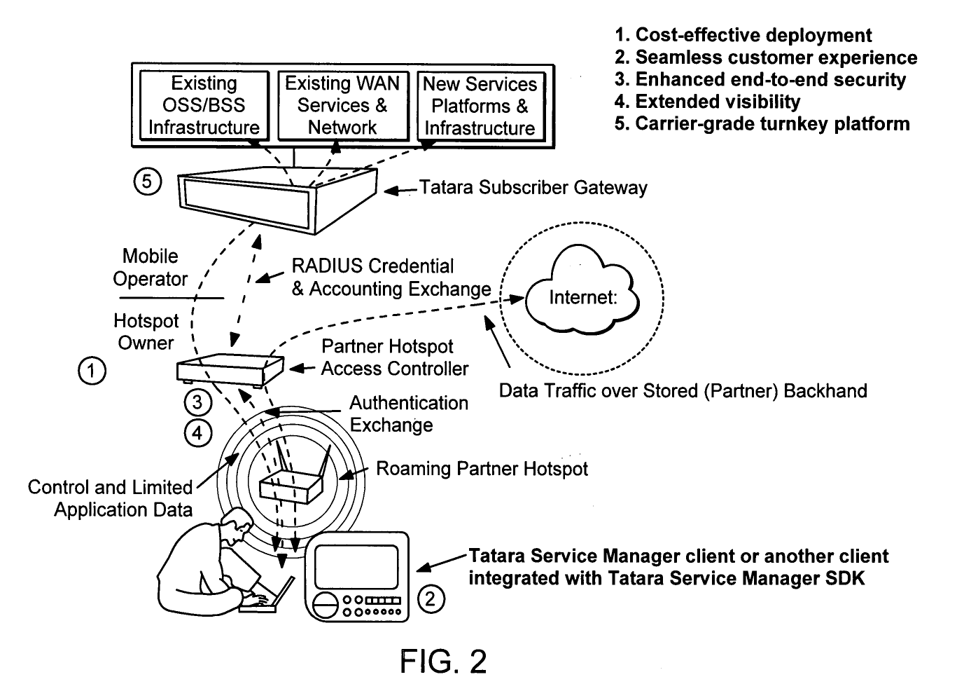

These needs can run counter to one another. For example, broad coverage implies many roaming partners—but this can have a negative impact on the simplicity of the end user experience and security. Reliable, high-quality service is facilitated by ownership of the backhaul—but this can ruin the economics of the business and make affordable pricing impossible. Access to applications are enabled when the retail provider owns the applications and the customer is not running a VPN—but a single provider can never control all of the potential applications and enterprise customers will need a VPN to access corporate networks and applications. As shown in FIG. 2, the Wi-Fi Service Delivery Platform for retail service providers can include two components: a Subscriber Gateway and a Service Manager.

The Subscriber Gateway is a centrally deployed and managed network device that controls multiple aspects of Wi-Fi services for a branded retail service provider. The Subscriber Gateway enables retail service providers to work with a broad set of roaming partners. It facilitates these partnerships through automated configuration and management capabilities and extends control by delivering a unique set of audit and visibility capabilities. A rich set of real-time presence, location and reachability capability works in conjunction with the Service Manager software to enable the branded retail service provider to maintain unprecedented control over their end subscribers. This same capability provides significant visibility into critical usage and performance data and ensures the consistent delivery of advanced services. The Subscriber Gateway does not require the deployment of any proprietary hardware or software on a partner network, nor does it require expensive backhaul changes to the network like many alternative solutions.

The Service Manager is client software that runs on an end user's Wi-Fi enabled laptop or PDA or other portable client device. Issued by the retail service provider who owns the relationship with the end user, the Service Manager software provides a carrier-branded user interface and secure connection management capability across multiple networks (e.g. Wi-Fi, GPRS, EDGE, 1xRTT, EVDO, UMTS). When deployed in conjunction with the Subscriber Gateway (see above), the capabilities are extended to offer unique control, visibility, service integration and mobility features. The Service Manager is designed to work with a broad set of networks and standards—enabling roaming onto partner networks without requiring these networks to conform to a single standard authentication mechanism.

Further details of the Wi-Fi Service Delivery Platform for retail operators are provided in U.S. patent application Ser. No. ______, entitled WI-FI SERVICE DELIVERY PLATFORM FOR RETAIL SERVICE PROVIDERS, (Attorney Docket No. 113-300-128) filed on even date herewith, which is incorporated by reference herein in its entirety.

With respect to the wholesale solution, the Service Delivery Platform in accordance with one or more embodiments can include several advantageous features and capabilities. For instance, the platform can provide (1) carrier-grade reliability via a clustered and load balanced architecture, (2) enhanced network management and alerting support via SNMP events, (3) RAID support, and (4) configurable backup and restore support.

Capabilities of a Partner in accordance with one or more embodiments for a wholesale service provider can include (1) an advanced roaming partner policy management capability, allowing management of subsets of Wi-Fi footprint, (2) wizards to simplify configuration of roaming relationships, and (3) an ODBC interface to export records to external systems for easy reporting and data manipulation by operators.

More particularly, wholesale solutions in accordance with one or more embodiments of the invention can include one or more of the following advantageous features:

1. The solution can provide brokering of Wi-Fi networks without requiring hardware to be deployed at partner hotspot networks. This can be accomplished by the Partner Gateway being able to connect to standards based input from hotspots.

2. The solution can provide brokering without requiring dedicated backhaul connections to the wholesale provider network. This can be accomplished because the Partner Gateway is a control path product.

3. The solution can provide the ability to manage Wi-Fi roaming partnerships including technical and business agreements. This can be accomplished via an easy to manage user interface that supports a number of complex parameters.

4. The solution can enable authentication with SS7 networks. This can be accomplished by the Partner Gateway functioning as a VLR for GSM/GPRS networks.

5. The solution can support wholesale operations with different types of retail providers, including CDMA, GSM/GPRS, Wireline, Cable, etc. This can be accomplished by the Partner Gateway providing a generic modular architecture.

6. The solution can provide a turnkey platform that integrates into an existing wholesale operators network architecture. This can be accomplished by the Partner Gateway providing standard interfaces with a number of core OSS/BSS systems.

7. The solution can support hierarchical roaming agreements. This can provide the wholesale operator the ability to integrate with other wholesale operators. The Partner Gateway can have the ability to manage hierarchical domains for proxy.

8. The solution can support footprint policy management. This capability can provide the ability to specify and enforce policies on the subset of Wi-Fi networks that are made available to different retail provider partners.

Wholesale Solution: Partner Gateway

Design Challenges

The wholesale solution in accordance with one or more embodiments can address several key challenges in aggregating and wholesaling public Wi-Fi services. These can include: (1) aggregation and management of heterogeneous Wi-Fi footprint operators, (2) brokering and managing technical and business agreements between Wi-Fi footprint operators and retail service providers, and (3) turnkey deployment, while leveraging existing infrastructure for billing and settlement.

Partner Gateway: Capability Details

A Partner Gateway in accordance with one or more embodiments of the invention can offers functionality around the following areas:

(1) Partner and Location Management: Partner and location management address management of logistics associated with the Wi-Fi service, including roaming partner setup, Wi-Fi footprint and location management.

(2) IP and SS7 authentication Brokering: Manages brokering of authentication information between Wi-Fi network operators and retail service providers for both IP and SS7 based authentication mechanisms.

(3) Usage Reporting and Settlement: Enables generation of usage information for settlement and reporting, and enables delivery of usage information to retail partners for end-user billing.

Each of these capabilities is described in further detail below.

Partner and Location Management

Partner Management:

This capability allows wholesale operators to manage logistics associated with the Wi-Fi service, including Wi-Fi network partner configuration, retail service provider partner configuration, and Wi-Fi footprint management through HTML-based GUI or through automated scripts in the CLI.

Partner Policy Management:

Wholesale operators can have the ability to specify and enforce policies on footprints available to different partners. For instance, some retail partners may be allowed to access a subset of the hotspot partners that are part of the wholesale operator's total footprint. The Partner Gateway partner policy management capability allows the configuration of such policies.

Location Management:

This capability enables wholesale operators to capture and manage the database of home and partner network locations, including automated import and export of partner locations in customizable or other formats. Location directory information may be delivered to retail partners for distribution to end-users customers.

IP and SS7 Authentication Brokering

The Partner Gateway can allow wholesale operators to manage brokering of authentication information between Wi-Fi network operators and retail service providers.

IP Authentication:

This functionality can support secure proxy of RADIUS information (MD5, PEAP, EAP SIM) from Wi-Fi operators to appropriate realms in retail service provider networks.

SS7 Authentication:

This functionality can support SS7 authentication over GSM MAP for GSM partner networks—the Partner Gateway functions as a VLR from the point of view of the HLR in the retail service provider network.

Usage Reporting and Settlement

This functionality enables the generation of usage information for settlement and reporting, and enables delivery of usage information to retail partners for end-user billing:

Wi-Fi Accounting Generation:

The Partner Gateway can collect usage information for each session, augments it with Wi-Fi specific information and captures it in a Data Record (TDR).

Usage Delivery

The collected usage information is delivered to billing and settlement systems. The output format may be TAP3 (v10) or any other customizable format.

Reporting

Real-time reporting of usage, based on Wi-Fi partners, retail partners, locations, and time; reports can be viewed graphically as well as delivered via FTP to other systems. An ODBC interface is provided in the Partner Gateway, whereby usage records may be accessed from a third party system for further analysis and reporting.

Settlement

The Partner Gateway can support generation of settlement records via TAP3 or customized formats for settlement between Wi-Fi and retail partners.

Partner Gateway: Deployment

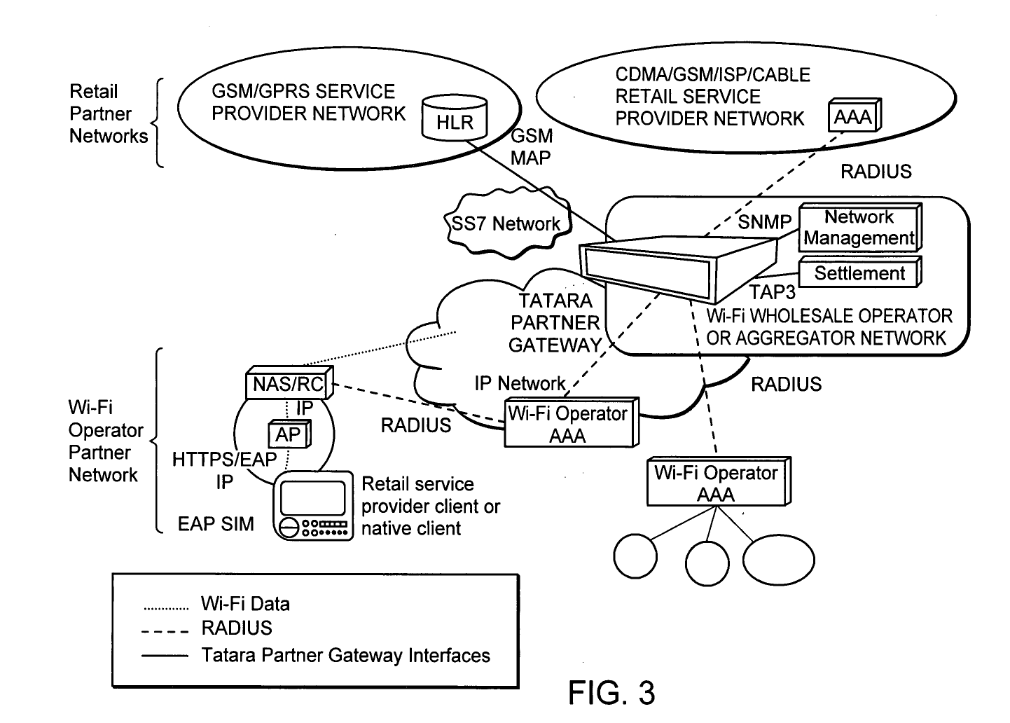

FIG. 3 shows a typical deployment architecture for the Partner Gateway in accordance with one or more embodiments of the invention in a wholesale operator's network and demonstrates how a wholesale operator may be able to offer wholesale Wi-Fi services on its aggregated Wi-Fi footprint.

As shown in the figure, the Partner Gateway is deployed in the wholesale operator's network operations center.

Wi-Fi operator network interfaces: The Partner Gateway interfaces with the Wi-Fi network over an IP interface. Note that the Partner Gateway is a control path product and does not require dedicated backhaul from the Wi-Fi network to the Partner Gateway. It also does not require the deployment of any additional equipment at the hotspot. The Wi-Fi networks forward authentication information to the Partner Gateway.

Retail service provider network interfaces: The Partner Gateway forwards retail subscriber authentication requests to the retail service provider core network. This can be either a SS7 request to the retail service provider's HLR or an IP RADIUS request. For instance, if the wholesale operator wholesales its service to a GSM provider, the Partner Gateway may allow SS7 based authentication into the GSM network. Similarly, the Partner Gateway also provides RADIUS proxy interface to other partner networks, including CDMA operators, wireline operators, or GSM operators that don't want to use SS7 authentication. The Partner Gateway also generates settlement and reporting data for the wholesale Wi-Fi service.

Partner Gateway: Underlying Platform

The Partner Gateway in accordance with one or more embodiments is a carrier-class gateway preferably running an embedded, hardened, real-time operating system based on the Linux Debian kernel. In addition, the Partner Gateway can be deployed in a clustered architecture that provides reliability as well as load balancing.

Clustering is generally driven by two requirements: (1) high availability service, providing 99.999% reliability, without loss of usage data for billing purposes or loss of service experience by end users; and (2) performance improvement through scaling.

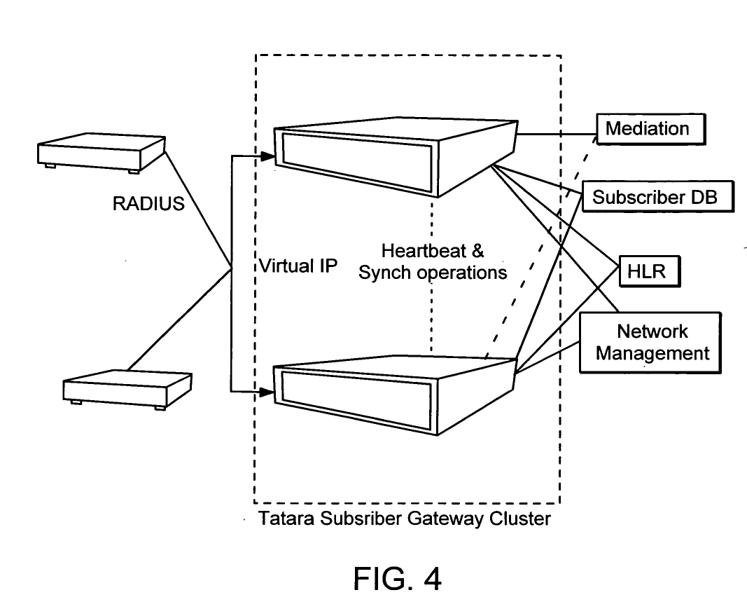

One example of the overall clustered solution is described in FIG. 4. As shown, the Partner Gateway cluster is deployed in the service provider network. The cluster is addressed by a single virtual IP address. The IP address is owned by the node that is the cluster ‘master’ (typically the node with the lower ID). RADIUS clients/proxies communicate with the virtual IP address. This request is received by the cluster master, which assigns the transaction to the appropriate node in the cluster. On the back end, each Partner Gateway communicates with the subscriber database or HLR for authentication. Mediation systems retrieve data from one of the nodes in the cluster, since usage information is replicated on both nodes. The nodes within the cluster exchange heartbeat messages for checking the health of the cluster.

This solution in accordance with one or more embodiments of the invention meets the two requirements required of a clustered solution. First, even if one node were to go down, there is no loss of data or service interruption. All usage data is replicated on each cluster—as a result there is no loss of data for billing purposes. Further, there is no bearer path traffic through the Partner Gateway, so there is no loss of service from the user's perspective.

The Partner Gateway device can be configured and managed through any of several mechanisms. First, a robust, secure, web-based management interface enables full configuration and device management from any standard web browser. Second, a command line interface (CLI) provides full configuration and management capabilities and allows for easy scripting by a carrier of common command sequences. Finally, a SNMPv3 interface allows the Partner Gateway to be configured remotely and managed through an external network management system. A variety of user privilege levels and security settings can be used to prevent unauthorized management system access and allow graduated user access for various functional operations.

Partner Gateway: System Architecture

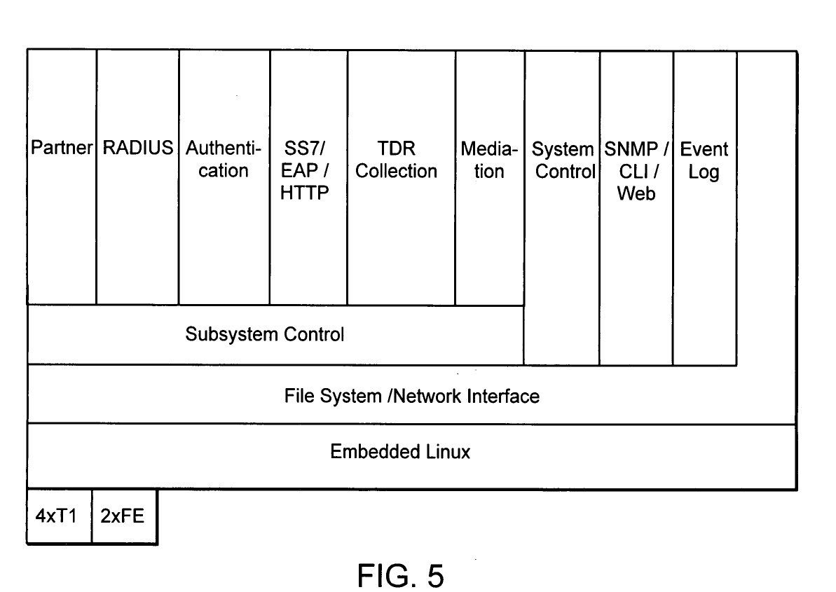

The software modules in the Partner Gateway platform in accordance with one or more embodiments of the invention are shown by way of example in FIG. 5. The key modules can include:
1. Partner: This module manages the various aspects of partner management, as described earlier.
2. RADIUS: This module implements a RADIUS interface to connect with the RADIUS clients deployed in Wi-Fi hotspots. It can support the standard RFCs, including 2865, 2866, 2869. The RADIUS module proxies messages to the retail service provider network.
3. Authentication: This module supports the core authentication modules, including all the 802.1x protocols such as MD5, PEAP, and EAP SIM.
4. SS7: This module implements the SS7 interface to HLRs using GSM MAP (29.002). It can support both ANSI and ITU versions.
5. Session Manager: This module implements the core real-time session management capability in the system. It maintains real-time state for all the active sessions in the system and writes usage data to the TDR collection module.
6. TDR Collection: This module stores session usage data and provides management access including report generation.
7. Mediation: This module provides the external interface with mediation, rating and settlement platforms via FTP. Data is formatted into GCDR or TAP3 formats and can be delivered to the downstream systems. Additional support for IPDR is planned in an upcoming release.
8. System Management: This forms the underlying management layer within the platform. It is based on SNMP and is used to control the underlying management of the platform. Both the Web interface and Command Line Interface (CLI) utilize the management layer for consistency and completeness.

In addition to these modules, there are other storage subsystems that store location information within the Partner Gateway.

The platform itself can be implemented on a Linux kernel and has multiple Ethernet and T1/E1 network interfaces. The T1/E1 interfaces are optional and required only if GSM MAP SS7 authentication is enabled. The underlying software architecture is based on a fully-managed, multi-process paradigm. Each core module is implemented as a separate process and processes communicate via an efficient, reliable socket-based inter-process communication mechanism. The modules are designed for resiliency with the help of watchdog timers. Multi-node reliability is enabled via a clustered approach for high availability.

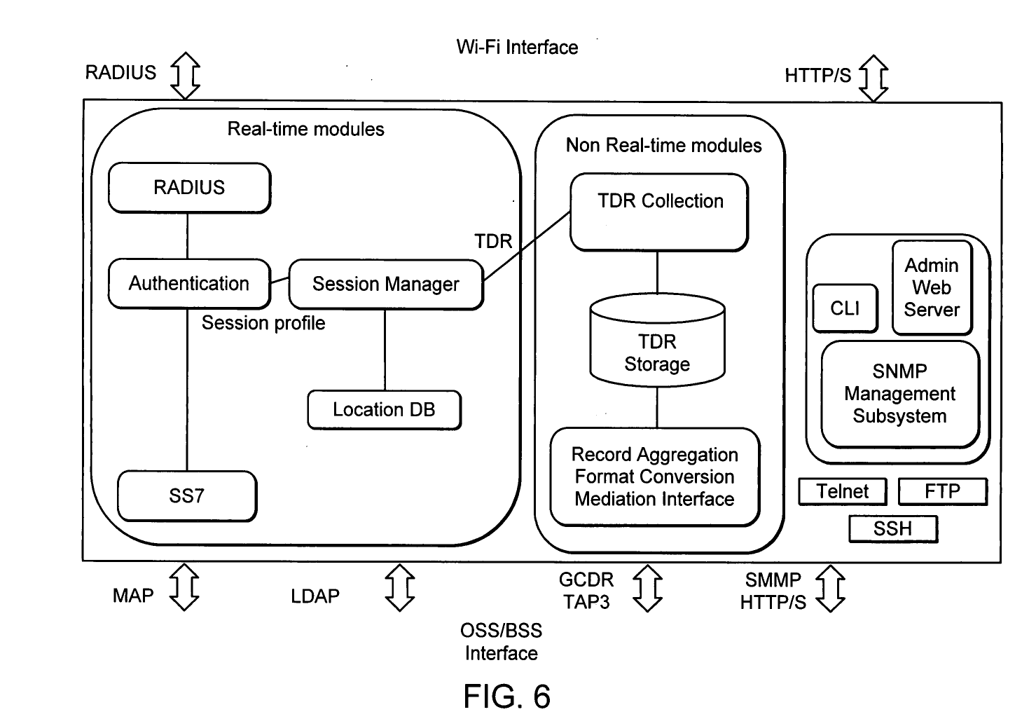

FIG. 6 illustrates the system architecture of a Partner Gateway in accordance with one or more embodiments of the invention.

RADIUS provides external connectivity on the IP side. The RADIUS module interfaces with the RADIUS client or proxy in the hotspot network to receive RADIUS authentication and accounting messages. The RADIUS messages are then proxied to the appropriate service provider network, depending on the proxy relationships. The Session Manager is the central module, which interfaces with the other system modules. When it receives RADIUS requests from the RADIUS module, it creates a new session. As RADIUS sessions are proxied through the system, it tracks the session information. In the case of SS7 authentications, the authentication module converts EAP SIM messages and passes them to the HLR. As the session progresses, the Session Manager collects usage information. At the end of the session, the Session Manager generates a session TDR (Data Record). The TDR is sent to the TDR collection module at the end of the session. The Mediation module formats the TDR to a format acceptable by the external mediation/settlement systems and delivers the data to mediation/settlement systems for further processing by the service provider infrastructure.

As shown in the figure, the underlying system is managed through an SNMP infrastructure, which can be accessed via the HTTP/S interface as well as the command line interface. CLI is accessible locally or remotely via Telnet and SSH. Operations that require file transfers are supported with an embedded FTP client and server. External database access to accounting records and reports is supported via the ODBC interface. The partner and location management functionality is accessed through either of these interfaces and the data is stored internally within the Partner Gateway.

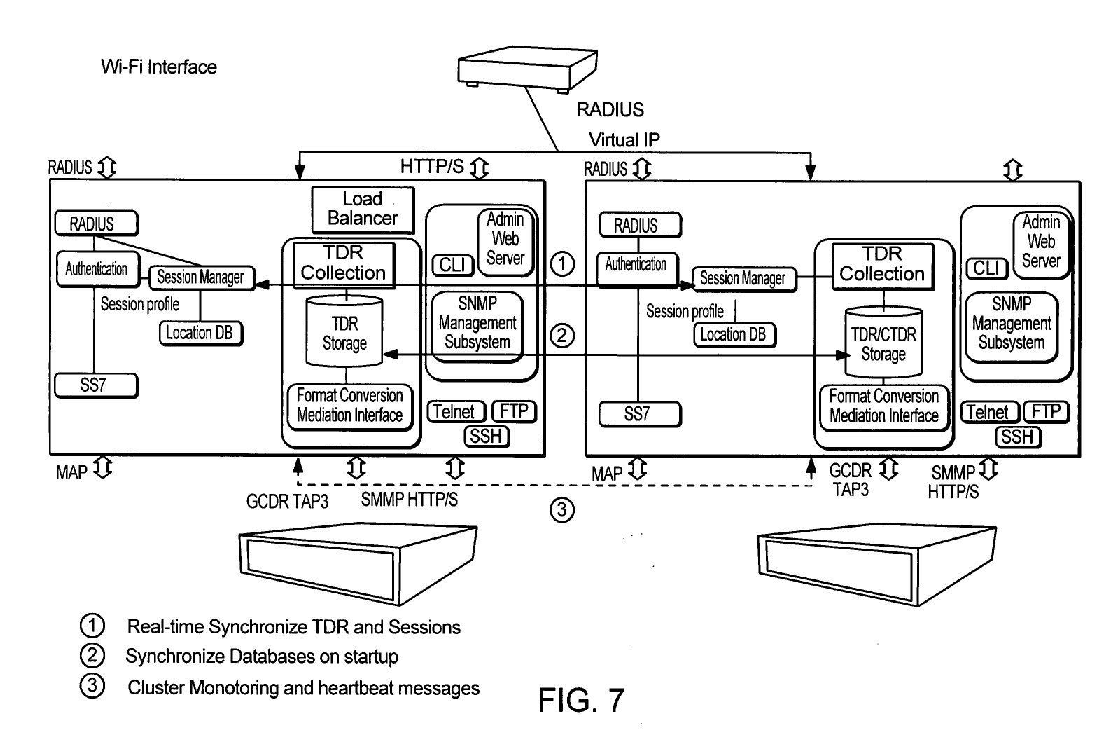

Details of the clustered solution are described through FIG. 7. As shown in the figure, the session manager replicates information across the cluster. As a result, TDRs and CTDRs are processed by both systems. This ensures that usage is available in both nodes in the event of a failure. When a new node is added into the cluster, it first synchronizes the database before becoming active within the cluster. This ensures that the bulk of synchronization is done before it enters the cluster for better performance.

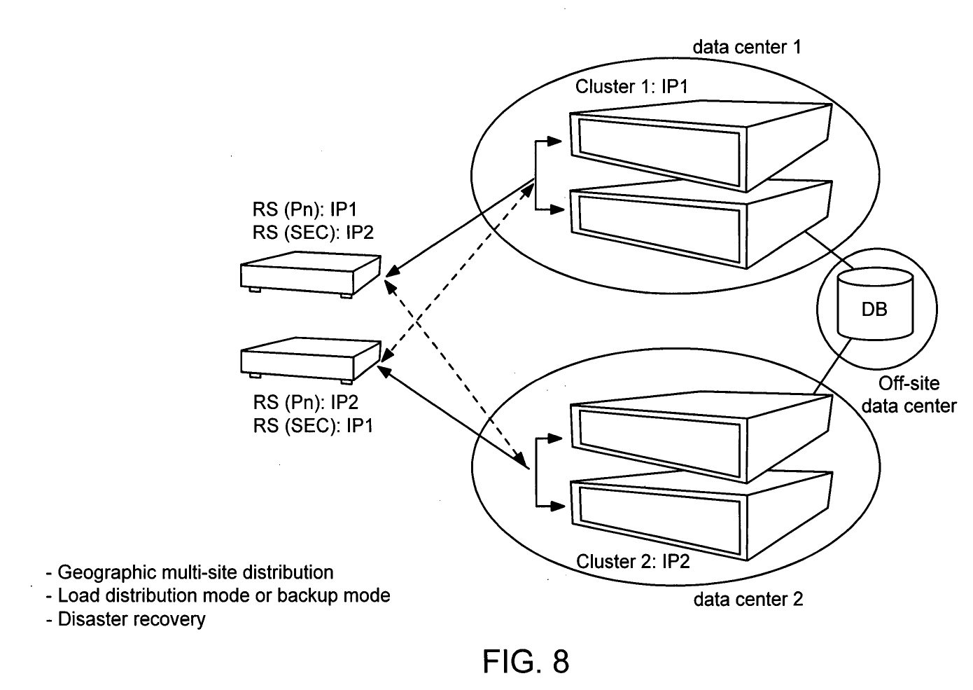

Multi-site clustering for increased reliability and disaster recovery can also be supported. An overview of a deployment is shown in FIG. 8. As shown in the figure, multiple Partner Gateway clusters can be deployed in different sites. Each cluster has its own IP address. The RADIUS clients or proxies in the Wi-Fi network use their primary and secondary RADIUS server configurations to point to the two clusters.

The multi-site clusters can be deployed in a number of ways, including the following:
(1) Load distribution mode: In this case, some RADIUS clients point to one cluster as the primary and use the second cluster for a backup, while other RADIUS clients point to the other cluster as a primary. This deployment provides geographic load sharing.
(2) Back up mode: An alternative is to use one cluster as the primary cluster for all traffic and the second cluster as the backup.

Note that this solution does not replicate sessions across clusters; it replicates usage data for completed sessions across the clusters. This guarantees service operation but there might be some loss of session information while the backup cluster kicks in. Frequent backup of data allows most billing information to be captured.

Partner Gateway: Software Architecture

The different modules within the Partner Gateway are called ‘subsystems.’ Each subsystem is derived from the base subsystem class that provides control, management, and integration services. The following summarizes the services provided by the base class.

1. Execution Control
(a) Startup—a master process starts and restarts each subsystem in the event of a crash, but prevents rapid restarting.
(b) Control loop—main process loop for supporting all common subsystem services with hooks for subsystem specific functions.
(c) Resource Limits—Memory, CPU, and Stack limits prevent single process from starving the rest of the system.
(d) Signal Handlers—Handlers for all Unix signals prevent uncaught signals from terminating subsystems.
(e) Shutdown—support for orderly shutdown including notification to management and other subsystems.

2. Event Logging
(a) Registration of subsystem specific events with the central Event Log.
(b) Event filtering through management (by level, subsystem, or event ID).
(c) Real time event logging to the central Event Log subsystem.

3. Timers
(a) Support for asynchronous, one-shot or repeatable timers.
(b) Granularity down to microseconds.

4. InterProcess Communications (IPC)
(a) Support for message and C++ object passing with other subsystems.
(b) Uses reliable Unix Domain Sockets.
(c) Non blocking, queued sends prevent unwanted context switching.
(d) Detection when remote subsystem goes up or down.

5. SNMP Subagent
(a) Maintains an IPC connection to the central SNMP Master Agent (MA).
(b) Supports a common Subsystem MIB for monitoring the process state, memory usage, IPC status, etc.
(c) Supports registration of subsystem specific MIBs with the Master Agent.

6. Cluster Membership
(a) Subsystems can declare themselves as “cluster-aware” in the constructor.
(b) A cluster-aware subsystem receives notifications when other nodes in the cluster come up or go down.
(c) Cluster-aware subsystems require external IPC connections to pass messages to other nodes in the cluster (the subsystem base class supports internal and external reliable IPC support).

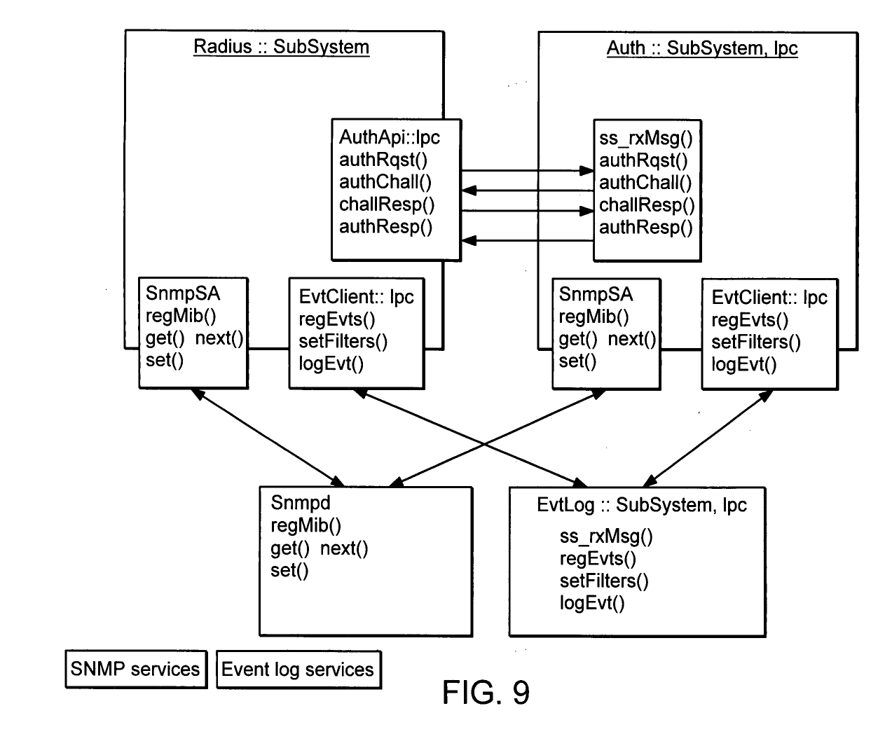

FIG. 9 illustrates an example of how two gateway subsystems can be integrated. Both Subsystems are derived from the base Subsystem that provides all the services listed above. Both have an event client that connects to the central Event Log and an SNMP Subagent that connects to the central SNMP Master Agent for MIB support. In this example, the Authentication subsystem (Auth) provides an API to the Radius subsystem. The API methods send and receive non-blocking IPC messages to/from the Auth subsystem.

Data Record (TDR): As mentioned earlier, the Partner Gateway stores session information in an internal data format called the Data Record. The TDR collects usage generated by RADIUS, and augments it with Wi-Fi specific information such as location and service plans.

Table 1 below shows the attributes of the Data Record. These augment information from the RADIUS record with location and service plan information.

| Field | Description |
|---|---|
| User Realm | Realm used to authenticate this user |
| User Id | User Id (User Name, Phone Number of IMSI) used |
| | to authenticate this user |
| Device Id | Device Id that the User connected to the session |
| | with |
| Start Time | Start time of the session |
| End Time | End time of the session |
| Gateway Id | ID of Tatara Gateway |
| Gateway Session Id | The Session Id given to a session by the Tatara |
| | Gateway |
| Error Code | Error code for the session |
| User Name | The User Name of the subscriber |
| Phone Number | The Phone Number of the subscriber |
| IMSI | The IMSI of the subscriber |
| NAS Id | The Id of the Network Access Server |
| NAS Certificate Id | The Id of the Network Access Server security |
| | certificate |
| NAS IP | The IP Address of the Network Access Server |
| NAS Session Id | The Session Id given by the Network Access Server |
| Location Partner | Location Partner providing service at this location |
| Location Id | Id of this location |
| Location Name | Name of this location |
| Location Address | Location Address of this location |
| Location TZ | Offset of this location from GMT |
| Location DST Flag | Was DST in effect |
| Location Category | Location Category of this location |
| Auth Method | Authentication Method used |
| Auth Proxy | Was this authentication proxied |
| Interims | Number of Interim Accounting records |
| Bytes In | Bytes Transferred In during session |
| Bytes Out | Bytes Transferred Out during session |
| Packets In | Packets Transferred In during session |
| Packets Out | Packets Transferred Out during session |
| Session Duration | Duration of Session |
| Term Cause | Cause of the session termination |

Partner Gateway: Operation

The operation of the system is described next. The operation can be divided into three steps: (a) system setup, (b) service setup, (c) run-time operation.

System Setup:

The system setup process includes starting and configuring the Partner Gateway. Parameters that are typically configured include the network settings (IP address, DNS, DHCP, etc.), SS7 settings (link settings, point codes, etc.) as well as security settings (certificate management). These configuration options are available from the different tabs on the Partner Gateway interface.

Service Setup:

The service setup process involves configuring the system to set up Wi-Fi partner information as well as to set up connections to the retail service providers. (Note that the Partner Gateway does not require or assume the presence of a Subscriber Gateway to deliver its whole set of services.)

Wi-Fi Operator Partner Configuration: This step allows the wholesale service provider to configure Wi-Fi network connection settings for all its footprint partners. This includes specifying the RADIUS clients, associated shared secrets, etc. so that the hotspot partner can send RADIUS information to the Partner Gateway. As part of partnership setup, the partner also needs to configure its RADIUS server to proxy authentication and accounting requests to the Partner Gateway.

Retail Service Provider Configuration: This step allows the wholesale service provider to configure the proxy settings for the retail service provider partner. In this case, the retail service provider actually provides service to their end customer, while getting footprint from the wholesale operator. The configuration involves setting the right proxy settings so that the Partner Gateway can forward requests authentication requests to the retail provider's network. (In case the retail service provider partner is using SS7 authentication, this step would also involve configuration of the SS7 settings such as point codes.)

As a result of configuring steps 1 and 2 above, if, e.g., ABC Wireless is the retail service provider, Wi-Fi Operator is the hotspot operator, and Aggregator is the wholesale operator, then when user@abcwireless.aggregator.com comes to the hotspot:

The Wi-Fi operator RADIUS proxy forwards abcwireless.aggregator.com requests to Aggregator's network (as part of configuration step 1)

The Partner Gateway then proxies user@abcwireless.com to the RADIUS servers in ABC Wireless' infrastructure.

Location Configuration: In this step, the wholesale service provider configures Wi-Fi footprint information. This can be done by specifying the location information associated with each partner. The location information includes a list of AP's, NAS, etc. that are part of the footprint as well as address, phone number, etc. This information can be used to generate a location directory that is communicated to the retail service provider. The retail service provider, in turn, sends the location directory to their customers. Note that as new partners are added or as new locations are added, the operator can configure the system to add the new information without affecting the run-time operation of the system. The Partner Gateway automatically generates the updated location directory that can be used for distribution to the client.

Mediation Configuration: The mediation interface on the Partner Gateway can deliver formatted mediation records to the downstream mediation or settlement systems in the aggregator network. Typical configurations on the mediation system include setting the location of the mediation system, configuring the frequency of mediation runs, etc.

Run-time Operation

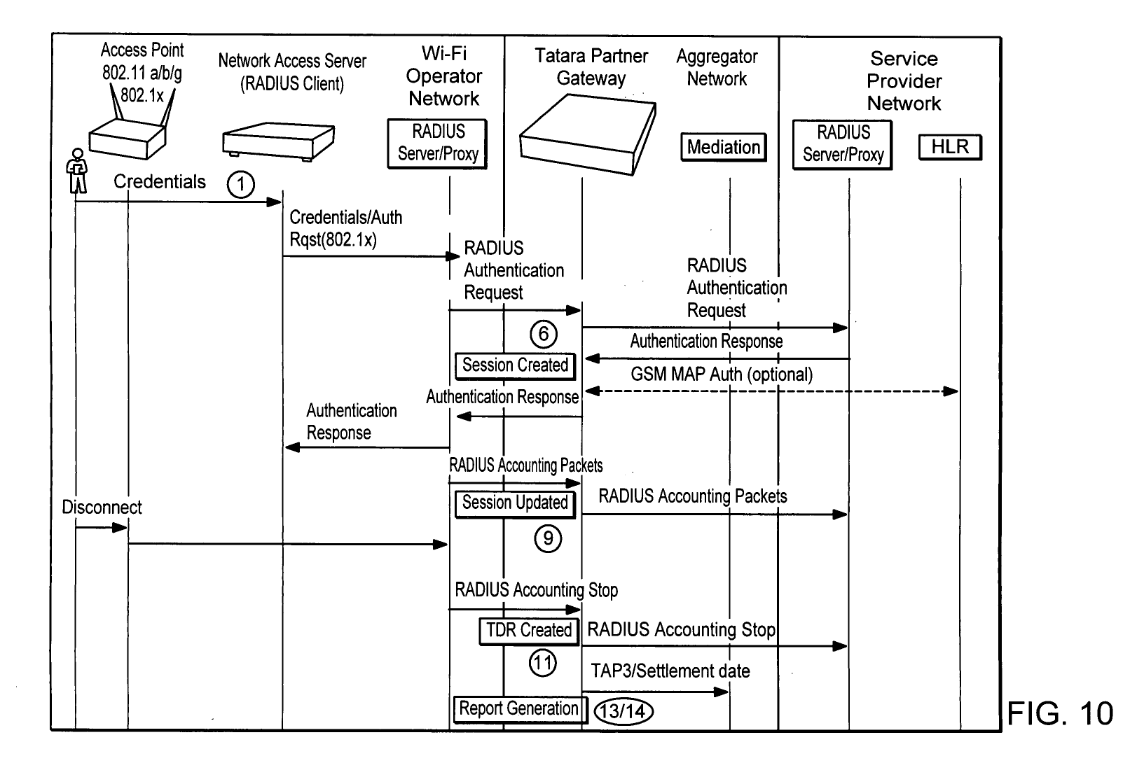

The wholesale operator signs up footprint partnerships and makes the footprint available to their retail service provider partners. The retail service provider's customers come to the aggregated hotspots. No requirements are made on the retail provider network or on the client running on the retail subscriber's terminal. The following sequence of events describes exemplary operation of the Partner Gateway when a retail service provider's customer (e.g. user@abcwireless) enters a hotspot operated by the wholesale operator's Wi-Fi partner (see FIG. 10 for a specific call flow).

1. User comes to a hotspot and provides authentication credentials. For instance, a customer of ABC Wireless sends his login information as user@abcwireless.aggregator.com.

2. The authentication information is received by the hotspot RADIUS client and forwarded (via possible intermediate proxy servers) to the Partner Gateway. As part of the Wi-Fi partnership setup process, the RADIUS proxy in the hotspot network is configured to forward realm-based requests to the appropriate Partner Gateway in the service provider network.

3. The RADIUS module in the Partner Gateway receives the authentication request and proxies it to the appropriate retail service provider network—in this case to ABC Wireless. Recall that this proxy configuration was set up as part of the retail provider configuration process.

4. Alternatively, if the user were using a SIM for authentication, the Partner Gateway receives EAP SIM messages. The Partner Gateway can process this in one of two ways. First, the Partner Gateway can proxy EAP SIM to the retail service provider's RADIUS server. Second, the Partner Gateway can send GSM MAP messages to the retail service provider's HLR.

5. The retail provider authenticates the user and sends the response back to the Partner Gateway, which then proxies it to the hotspot operator.

6. The Partner Gateway creates and maintains a session for this subscriber.

7. As the session proceeds, the hotspot RADIUS server/proxy sends RADIUS accounting messages to the Partner Gateway.

8. The accounting information is sent to the Session Manager in the Partner Gateway as well as proxied to the retail provider's network.

9. The Session Manager updates the session status with usage information.

10. When the session terminates, RADIUS receives a session stop message. The Partner Gateway also proxies this information to the retail provider network.

11. The Session Manager updates the session information and generates a TDR (Data Record). This record is sent to the TDR collection module.

12. The usage information for all sessions is collected in an internal SQL database.

13. Usage reports based on time, location, partner, etc. may be run on the internal SQL database via the Partner Gateway user interfaces.

14. The Mediation module runs at a programmable frequency and converts the TDRs into the appropriate format records (e.g. GPRS CDRs or TAP3 records) and delivers them to the mediation or settlement system for use by the wholesale operator.

In addition to the above real-time session sequence, an administrator can use the Web or CLI interface on the Partner Gateway to manage the gateway at any time.

The service delivery platform thereby enables wholesale service providers to aggregate and wholesale Wi-Fi services. Advantageous features of the platform in accordance with one or more embodiments of the invention can include the ability to support a predominantly roaming Wi-Fi environment through an architecture that offers:
(1) hardware-agnostic hotspot support, where no additional hardware or software has to be deployed in Wi-Fi networks (enabling wholesale operators to integrate heterogeneous roaming partner networks into their existing footprint);
(2) backhaul-agnostic hotspot support, where no dedicated backhaul needs to be provided at Wi-Fi locations (enabling wholesale operators to quickly and cost-effectively aggregate a Wi-Fi service without the costs and delays involved with provisioning and operating dedicated networks);
(3) an easy-to-use UI for managing roaming partnerships such as capturing and maintaining RADIUS information that scales across thousands of partners;
(4) an easy-to-use UI for managing location information, such as capturing AP, NAS locations, enabling generation of an up-to-date location database;
(5) supports flexible authentication mechanisms enabling retail service providers to efficiently work with aggregators; and
(6) supports a highly manageable solution that offers visibility and manageability of a secure carrier-class platform via SNMP, HTTPS, and CLI.

Some wholesale operators may also be interested in providing ‘hosted’ services for their retail service provider partners. In this case, the wholesale operator can also host the Subscriber Gateway, thereby managing the Wi-Fi service for retail operators. As previously mentioned, further details on Wi-Fi Service Delivery Platform for retail operators are provided in a patent application entitled WI-FI SERVICE DELIVERY PLATFORM FOR RETAIL SERVICE PROVIDERS, (Attorney Docket No. 113-300-128) filed on even date herewith, which is incorporated by reference herein in its entirety.

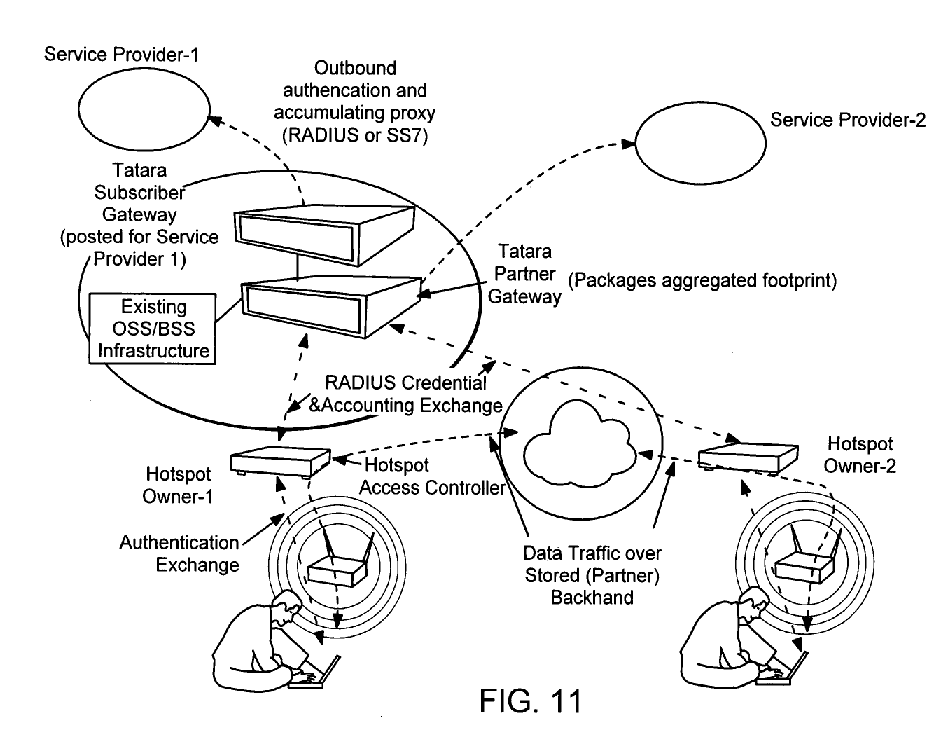

FIG. 11 shows a wholesale service provider hosting a Subscriber Gateway for a retail service provider in accordance with one or more embodiments of the invention. In this case, customers of the retail service provider get access to a client (branded appropriately) and the wholesale operator manages the Wi-Fi service for the retail service provider, in addition to aggregating and managing the wholesale service via the Partner Gateway.

In accordance with one or more further embodiments of the invention, the wholesale solution can leverage the service delivery infrastructure to build a framework for aggregation and delivery of content across different roaming partners. The Partner Gateway can enable wholesale operators to aggregate content among content providers and deliver it to different partners depending on business agreements. The applications can include location and presence services, messaging applications, and partner-specific applications.

Having described preferred embodiments of the present invention, it should be apparent that modifications can be made without departing from the spirit and scope of the invention.

1. A method for managing usage of a plurality of local area networks by a plurality of subscribers, each subscriber associated with one of a plurality of retail service providers, said subscribers each having a terminal for accessing one or more of said local area networks, for each attempt by one of said plurality of subscribers to access one of said plurality of local area networks, the method comprising the steps of:
(a) receiving at a gateway at a wholesale service provider network a request from said one of said plurality of local area networks for authenticating said one of said plurality of subscribers, said request containing subscriber credentials for said one of said plurality of subscribers;
(b) forwarding said subscriber credentials to a retail service provider with which said one of said plurality of subscribers is associated;
(c) receiving from said retail service provider authorization to grant access to said one of said plurality of local area networks when said one of said plurality of subscribers is authenticated based on said subscriber credentials and information relating to said one of said plurality of subscribers previously stored in a subscriber database;
(d) authorizing said one of said plurality of local area networks to grant access to said one of said plurality of subscribers when said one of said plurality of subscribers is authenticated;
(e) receiving session information from said one of said plurality of local area networks on usage of said one of a plurality of local area networks by said one of said plurality of subscribers; and
(f) transmitting said information received on local area network usage to said retail service provider for use in billing said one of said plurality of subscribers.

2. The method of claim 1 wherein said local area networks are wireless local area networks.

3. The method of claim 2 wherein said local area networks are Wi-Fi or WiMAX networks.

4. The method of claim 1 wherein step (a) comprises receiving a request for authenticating said one of said plurality of subscribers from a network access server at said one of said plurality of local area networks.

5. The method of claim 1 wherein said plurality of local area networks contain no hotspot components dedicated to said wholesale service provider network.

6. The method of claim 1 wherein data is transmitted between said gateway and said plurality of local area networks without using any dedicated backhaul between the gateway and said plurality of local area networks.

7. The method of claim 1 wherein data is transmitted between said gateway and said plurality of local area networks over a public IP network.

8. The method of claim 1 wherein said gateway has a generic modular architecture, and wherein said plurality of retail service providers provide different types of retail services.

9. The method of claim 8 wherein said retail services comprise CDMA, GSM, GPRS, wireline or cable service.

10. The method of claim 1 wherein said gateway has standard interfaces with core OSS/BSS systems.

11. The method of claim 1 wherein said gateway can be integrated with other gateways operated by other wholesale service providers.

12. The method of claim 1 wherein the subscriber database is an HLR or an LDAP database.

13. The method of claim 1 wherein information relating to said one of said plurality of subscribers previously stored in a subscriber database comprises information obtained in connection with another service offered by the retail service provider to said one of said plurality of subscribers.

14. The method of claim 1 wherein said plurality of local area networks comprises an aggregated footprint.

15. The method of claim 1 wherein each of said plurality of retail service providers is associated with a subset of said plurality of local area networks such that subscribers associated with a given retail service provider can access said subset of said plurality of local area networks associated with said given retail service provider.

16. The method of claim 1 further comprising generating a directory of local area networks accessible by said subscribers.

17. The method of claim 1 wherein step (f) comprises, for each retail service provider, collecting said information on local area network usage for a given period of time by subscribers associated with said retail service provider, and transmitting said information to said retail service provider.

18. The method of claim 1 further comprising configuring said gateway to include information on said plurality of local area networks.

19. The method of claim 18 wherein said information on each local area network includes information on local area network equipment, local area network location, or address of a RADIUS client associated with a local area network.

20. The method of claim 1 wherein the request for authenticating is based on a RADIUS connection or a DIAMETER connection between said local area network and said gateway.

21. The method of claim 1 wherein said subscriber credentials are forwarded in step (b) over a RADIUS connection or an SS7 connection.

22. The method of claim 1 wherein said terminals are laptops, personal digital assistants, or smart phones.

23. A gateway for deployment at a wholesale service provider network for managing usage of a plurality of local area networks by a plurality of subscribers, each subscriber associated with one of a plurality of retail service providers, said subscribers each having a terminal for accessing one or more of said local area networks, the gateway comprising:
a first interface module for communicating with said plurality of local area networks;
a second interface module for communicating with said plurality of retail service providers; and
a manager for receiving through said first interface module requests from said plurality of local area networks for authenticating subscribers desiring access to said plurality of local area networks, said requests containing subscriber credentials for said subscribers, said manager transmitting through said second interface module said subscriber credentials to respective retail service providers with which said subscribers are associated, said manager receiving from said retail service providers through said second interface module authorization to grant subscribers access to respective local area networks when said subscribers are authenticated based on subscriber credentials and information relating to said subscribers previously stored in a subscriber database, said manager authorizing said local area networks to grant access to authenticated subscribers through said first interface module, said manager also receiving session information from said plurality of local area networks on usage of said local area networks by said subscribers, and said manager transmitting said information received on local area network usage to said retail service providers for use in billing said plurality of subscribers.

24. The gateway of claim 23 wherein said local area networks are wireless local area networks.

25. The gateway of claim 24 wherein said local area networks are Wi-Fi or WiMAX networks.

26. The gateway of claim 23 wherein said plurality of local area networks contain no hotspot components dedicated to said wholesale service provider network.

27. The gateway of claim 23 wherein data is transmitted between said gateway and said plurality of local area networks without using any dedicated backhaul between the gateway and said plurality of local area networks.

28. The gateway of claim 23 wherein data is transmitted between said gateway and said plurality of local area networks over a public IP network.

29. The gateway of claim 23 wherein said gateway has a generic modular architecture, and wherein said plurality of retail service providers provide different types of retail services.

30. The gateway of claim 29 wherein said retail services comprise CDMA, GSM, GPRS, wireline or cable service.

31. The gateway of claim 23 wherein said gateway has standard interfaces with core OSS/BSS systems.

32. The gateway of claim 23 wherein said gateway can be integrated with other gateways operated by other wholesale service providers.

33. The gateway of claim 23 wherein the subscriber database is an HLR or an LDAP database.

34. The gateway of claim 23 wherein information relating to said subscribers previously stored in a subscriber database comprises information obtained in connection with another service offered by a retail service provider to said subscribers.

35. The gateway of claim 23 wherein said plurality of local area networks comprises an aggregated footprint.

36. The gateway of claim 23 wherein each of said plurality of retail service providers is associated with a subset of said plurality of local area networks such that subscribers associated with a given retail service provider can access said subset of said plurality of local area networks associated with said given retail service provider.

37. The gateway of claim 23 wherein said manager further generates a directory of local area networks accessible by said subscribers.

38. The gateway of claim 23 wherein said manager collects said information on local area network usage for a given period of time by subscribers associated with respective retail service providers, and transmits said information to said respective retail service providers.

39. The gateway of claim 23 wherein said manager is configured to include information on said plurality of local area networks.

40. The gateway of claim 39 wherein said information on each local area network includes information on local area network equipment, local area network location, or address of a RADIUS client associated with a local area network.

41. The gateway of claim 23 wherein the request for authenticating is based on a RADIUS connection or a DIAMETER connection between said local area networks and said gateway.

42. The gateway of claim 23 wherein said manager transmits said subscriber credentials over a RADIUS connection or an SS7 connection.

43. The gateway of claim 23 wherein said terminals are laptops, personal digital assistants, or smart phones.

44. A method for managing usage of a plurality of local area networks by a plurality of subscribers, each subscriber associated with one of a plurality of retail service providers, said subscribers each having a terminal for accessing one or more of said local area networks, for each attempt by one of said plurality of subscribers to access one of said plurality of local area networks, the method comprising the steps of:
(a) receiving at a retail service provider associated with said one of said plurality of subscribers a request from said one of said plurality of local area networks for authenticating said one of said plurality of subscribers, said request received via a gateway at a wholesale service provider network, said request containing subscriber credentials for said one of said plurality of subscribers;
(b) authenticating said one of said plurality of subscribers based on said subscriber credentials and information relating to said one of said plurality of subscribers previously stored in a subscriber database;
(c) transmitting to said gateway authorization to grant access to said one of said plurality of local area networks when said one of said plurality of subscribers is authenticated, said gateway transmitting to said one of said plurality of local area networks authorization to grant access to said one of said plurality of subscribers; and
(d) receiving from said one of said plurality of local area networks via said gateway information on local area network usage by said one of said plurality of subscribers for use in billing said one of said plurality of subscribers.

45. The method of claim 44 wherein said local area networks are wireless local area networks.

46. The method of claim 45 wherein said local area networks are Wi-Fi or WiMAX networks.

47. The method of claim 44 wherein said gateway receives a request for authenticating said one of said plurality of subscribers from a network access server at said one of said plurality of local area networks.

48. The method of claim 44 wherein said plurality of local area networks contain no hotspot components dedicated to said wholesale service provider network.

49. The method of claim 44 wherein data is transmitted between said gateway and said plurality of local area networks without using any dedicated backhaul between the gateway and said plurality of local area networks.

50. The method of claim 44 wherein data is transmitted between said gateway and said plurality of local area networks over a public IP network.

51. The method of claim 44 wherein said gateway has a generic modular architecture, and wherein said plurality of retail service providers provide different types of retail services.

52. The method of claim 51 wherein said retail services comprise CDMA, GSM, GPRS, wireline or cable service.

53. The method of claim 44 wherein said gateway has standard interfaces with core OSS/BSS systems.

54. The method of claim 44 wherein said gateway can be integrated with other gateways operated by other wholesale service providers.

55. The method of claim 44 wherein the subscriber database is an HLR or an LDAP database.

56. The method of claim 44 wherein information relating to said one of said plurality of subscribers previously stored in a subscriber database comprises information obtained in connection with another service offered by the retail service provider to said one of said plurality of subscribers.

57. The method of claim 44 wherein said plurality of local area networks comprises an aggregated footprint.

58. The method of claim 44 wherein step (d) comprises receiving information on local area network usage for a given period of time by subscribers associated with said retail service provider.

59. The method of claim 44 wherein said subscriber credentials are forwarded in step (b) over a RADIUS connection or an SS7 connection.

60. The method of claim 44 wherein said terminals are laptops, personal digital assistants, or smart phones.
